(19) United States
(12) Patent Application Publication
(10) Pub. No.: US 2003/0110442 A1
(43) Pub. Date: Jun. 12, 2003

(54) Developing documents

(76) Inventor: Steven Andrew Battle, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/275,243

(22) PCT Filed: Mar. 28, 2002
(86) PCT No.: PCT/GB02/01471

(30) Foreign Application Priority Data
Mar. 28, 2001 (GB) 0107766.8

(51) Int. Cl. G06F 17/00

(52) U.S. Cl. 715/500

(57) ABSTRACT

A method of facilitating the amendment of data is provided, said data comprising a presentation document that has been rendered from an original document. The method comprises marking the presentation document such that when the presentation document is amended the original document has corresponding amendments made thereto. The invention enables a user to amend/edit an original document indirectly in any convenient form they are familiar with in a WYSIWYG fashion, with the amendments being indirectly made to the original document.

This invention relates to an improved system and method of developing a document, particularly, but not exclusively for assisting in the development of a document for publication on a variety of media.

Many documents are now produced using computers. Such documents may be intended for printed publications, such as newspapers, magazines, books, etc. or for electronic publication, such as for e-mails, pages to be displayed on the World Wide Web, etc.

Page description languages are well known to achieve such computer-based preparation. These description languages provide instructions for a page renderer so that the final page can be produced from the given instructions. Therefore, the instructions provided to the renderer contain not only the content of the document, but also information about how the information should be arranged on the page (whether paper, or computer screen). Well known page description languages include LATEX, POSTSCRIPT, HTML.

The term “page description language” is used here to cover languages designed to represent the layout on a 2-dimensional medium. In addition to the printed page, this may include computer windows and smaller displays such as those found on handheld devices.

Cross-media publishing acknowledges the existence of a rich diversity of page description languages targeted for a wide range of media from the printed page to mobile telephones. There is a need to distinguish the content of a document from the aspect of its presentation. This so-called content document does not include layout information, and is for all intents or purposes, device or media independent. It would then be standard practice to apply a functional transformation to the content document to create a new document expressed in an appropriate page description language.

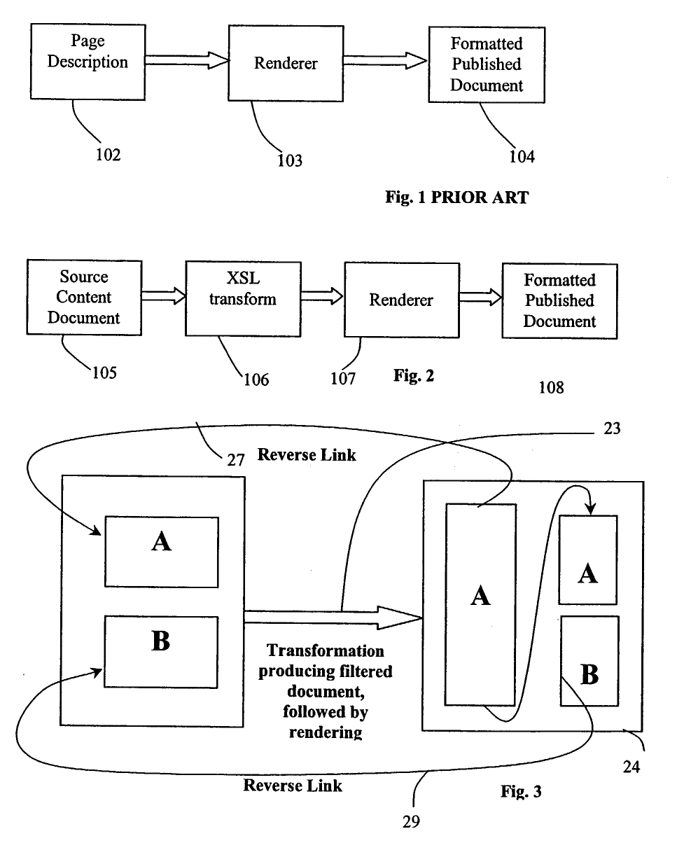

A problem with the use of such description languages is that a user cannot see what the finished document will look like until the instructions have been rendered, as shown in FIG. 1. Furthermore, the page description (or content document) can look different on different display medium (for example HTML documents can look different when displayed on different browsers). Therefore, when tweaking, and making final adjustments to a document, a user may have to continuously make adjustments to the content document, and render the page to see if the adjustment is satisfactory, possibly for each different display medium on which the content document is to be presented. This can be a time consuming practise.

If a user wishes to make an amendment to an electronic document that has already been published using a page description language, then they must edit the instructions that created the document, i.e. the page description or content document must be edited. On a document such as a web page this is relatively easy since the instructions are accessible. Where the same information is presented in many different media, each page description is edited separated. However, a lack of mechanisms to perform any cross-checking for inconsistencies between the information presented in different page descriptions may arise. In addition, changes to the page description will not be reflected in the original content description.

Content documents (and page descriptions) may be expressed in languages defined in XML (eXtensible Markup Language). Markup languages allow us to express data and meta-data within the same document; for example one can express the title of a document and also the fact that it is a title with the expression “<title>a title</title>”. Its extensibility is based on the idea that (unlike HTML) it does not define a fixed set of mark-up tags; developers and users are free to introduce their own mark-up for whatever task is in hand. While this invention is not predicated on the use of XML, these properties of XML are naturally aligned with it. While page layout mark-up normally uses a standard set of tags, content mark-up is largely unstandardised and relies on extensibility. XML is used to specify the information to be displayed. Unlike the traditional description languages described hereinbefore XML does not necessarily contain information relating to the layout of the published document, but may simply define the information held within the instruction document. The person skilled in the art will readily understand this.

In certain situations a transformation must be applied to the original content document, an XML document, to produce a formatted page description before being passed to the renderer for display, as shown in FIG. 2. One such example of a general-purpose transformed language is XSL language that may convert an XML instruction document into HTML for rendering. Changes made solely to the page description would be lost if the page description were recreated from the original content. The use of separate content and page descriptions makes it harder to modify documents.

A prior art desktop publishing software package is produced by Quark Inc. under the Trade Mark QUARKXPress™. A module to extend the capabilities of this package is available under the Trade Mark avenue.quark™. Avenue.quark™ allows a user to extract the content from a QUARKXPress™ document and export it as an XML file, which can be used to create web pages, etc. Avenue.quark™ provides windows in which the content and the XML can be viewed simultaneously. Avenue.quark™ also allows XML to be imported in to QUARKXPress™ documents. However, Quarks style templates have only limited application by comparison with XSL.

This invention tries to ameliorate at least some of the problems of the prior art.

According to a first aspect of the invention there is provided a method of facilitating the amendment of data, said data comprising a presentation document that has been rendered from an original document, the method comprising marking the presentation document such that when the presentation document is amended the original document has corresponding amendments made thereto.

An advantage of such a method is that a user can make a single amendment to the presentation document, without having to return to the original document transform and re-render the original document to see the corresponding change. As such, making amendments should be much quicker and easier than the prior art.

The skilled person will appreciate that portions of the original document will be mapped to portions of the presentation document by the rendering process, and further, that these portions may comprise portions of text, pictures, animations, links to sound files, etc. Preferably, the method comprises marking the presentation document by inserting links into it, linking a portion of the presentation document to its corresponding portion in the original document.

The links may comprise a path to the portion in the original. The links may be defined in a language such as xpath.

Preferably, the original document is written in a mark-up language. The mark-up language may be any language defined by one of the following: XML, SGML, or any other suitable mark-up language specification.

The skilled person will appreciate that an original document written in a mark-up language may contain both data and meta-data items represented as language specific tags. The tags for the data-items specify the content of the document, but will not generally indicate how the data is represented on a page.

The original document may be transformed to produce a transformed document that can then be rendered. An advantage of such a step is that a single original document can be transformed to a number of different output formats.

Conveniently, a style sheet or the like performs the transformation. The style sheet includes the use of XML schemas, XSL transforms, etc.

The transformed document may also be written in a page description language. Indeed, the transformed document may be written in any one of the following: HTML, WML, XML.

The method may produce a plurality of presentation documents. Each of said plurality of presentation documents may be designed for display on a different data-receiving device (for example a WAP telephone, an Internet browser, an ebook, a web enable television, etc.). Such a method is advantageous because it allows a single original document to be used a plurality of times, which is more efficient than having a plurality of original documents.

Conveniently, any transformation that is performed on the original document may pass only a portion of data-items appearing in the original document to the transformed document. An advantage of this feature is that a single presentation document can be used to generate a plurality of presentation documents, each having a different intended purpose. For example, the original document may comprise an address book containing both personal and work information. The transformation may be arranged to generate two separate address books as presentation documents: one containing personal information and one containing work information.

The method may provide a user with a set of tools to aid the user in marking the presentation document. Such tools may comprise providing tools that allow a user to create an appropriate transform. A user may be able to specify which data-items within the original document they wish to edit and the tool may automatically insert the required marks in the presentation document. Such marks may comprise inserting links in the transform and/or transform document.

Conveniently, the method only allows data-items that have a link and/or path associated with them to be edited, and therefore, prevents data-items without a path associated therewith from being edited. This may specifically prevent the user from editing elements introduced by the transformation that have no counterpart in the content document.

Preferably, the method comprises causing the presentation document to be displayed on one or more data-receiving devices remote from a processing circuitry holding the original document. Causing the data-receiving devices to display the presentation document may be achieved by transmitting the transformed document to one or more data-receiving devices, or by transmitting the original document to one or more data-receiving devices.

The, or each, data-receiving device may be networked to the processing circuitry. The network may comprise a Local Area Network (LAN), Wide Area Network (WAN), an Internet connection, an Ethernet network, IRDA link, a permanent/temporary connection, a wireless link, a Bluetooth link, etc.

The method may comprise having the data-receiving device transmit any presentation-document-edits that have been made to the presentation document displayed thereon to the processing circuitry. Such transmission allows the original document to updated.

Further, the processing circuitry may transmit any presentation-documents-edits that it receives to data-receiving devices that are displaying rendered versions of the original document. The presentation-document-edits may be received from data-receiving devices remote from the processing circuitry, or may be by software running on the processing circuitry itself. Such a method is convenient since it allows any data-receiving device that is displaying a version of the original document to be able to display an up to data version.

Preferably, transmissions specifying a presentation-document-edit specify the location of the edit within the original document, may be by including the path. Additionally, or alternatively transmissions specifying a presentation-document-edit specify just how the original document should be edited. An advantage of such a method is that it is relatively easy to amend the original document as required.

Conveniently, any transmission made by the processing circuitry to data-receiving devices that are displaying rendered versions of the original document includes the location of the edit within the original document, and/or the edit that has been made. Such a method is advantageous because it allows the data-receiving device to edit the rendered document that it is displaying, without having to re-render the original document.

A password may be required before one or more parts of a rendered document may be amended. The method may alternatively permit amending of a rendered document but may not update/make corresponding amendments to the original unless a correct password is provided. For example, the original document is a template with a field ‘YOUR NAME HERE’ and the user may amend the document when rendered to insert their name. This should obviously not overwrite the original document as it would provide the user's name to subsequent users. Nevertheless, the password allows authorised users to update the original by amending the rendered document, for instance to say “Please enter name” instead.

According to a second aspect of the invention there is provided a system comprising processing circuitry arranged to generate one or more documents suitable for transmission by a transmitter of the processing circuitry, wherein the processing circuitry inserts one or more links into the, or each, document such that when the, or each, document is rendered the location of data-items on the processing circuitry is specified within the rendered document.

The system may comprise one, or more, data-receiving devices arranged to receive the document produced and transmitted by the processing circuitry. The, or each, data-receiving device may be arranged to render the document for display thereon. An advantage of such a system is that it can be arranged to produce a plurality of documents suitable for display on a range of different data-receiving devices.

Alternatively, or additionally, the processing circuitry may be arranged to handle documents written in a mark-up language that specifies the presentation. Examples of a mark-up language that specifies the presentation include: HTML, WML.

The data-receiving device may be a data-receiving device according to the fifth aspect of the invention.

According to a third aspect of the invention there is provided a computer readable medium having stored therein instructions for causing a processing unit to execute the method of the first aspect of the invention.

The computer readable medium may be any one or more of the following: a floppy disk, a ZIP™ disk, an LS120 disk, a CDROM, a DVD ROM/RAM, any other form of magneto-optical disk, a transmitted signal, an email message, or any other suitable medium.

According to a fourth aspect of the invention there is provided a data-receiving device arranged to receive data suitable for rendering into a presentation document generated according to any one the preceding aspects of the invention from an original document.

The data-receiving device may any one or more of the following: a WAP telephone, a web-enabled television, a PC (or other web enabled computer e.g. an Apple), an ebook, a PDA, or any other similar data-receiving device.

The data-receiving device may be arranged such that it allows the presentation document rendered thereon to edited. An advantage of such a method is that it allows the presentation document to be altered without having to alter the original document, re-transform, re-transmit, and re-render it. This allows users to amend/edit an original document indirectly by way of a rendered page description, i.e. a rendered document. This allows them to amend the original in any convenient form they are familiar with in a WYSIWYG fashion.

Conveniently, the data-receiving device has a transmitter and is arranged to transmit any edits that are made to the presentation document displayed thereby. An advantage of such a data-receiving device is that it allows the processing circuitry that provided the original document to receive the edits and update the original document.

The data-receiving device may be arranged such that the transmitter only transmits the edit once the edit has been completed. Such an arrangement is likely to be more efficient than other arrangements in which the edit is transmitted more often.

There may be further ways of looking at the invention. For instance the invention may comprise providing a method of organising data on a primary processing apparatus; it may comprise increasing the speed of developing a document; it may comprise provide a method of ensuring that a data is correctly received by a number of data-receiving devices. A system may also be provided for performing the methods mentioned in this paragraph.

There now follows by way of example only a detailed description of the present invention with reference to the accompanying drawings of which:

FIGS. 1 and 2 show block diagrams for the prior art;

FIG. 3 shows a schematic layout for a typical computer system that may be used to provide the present invention;

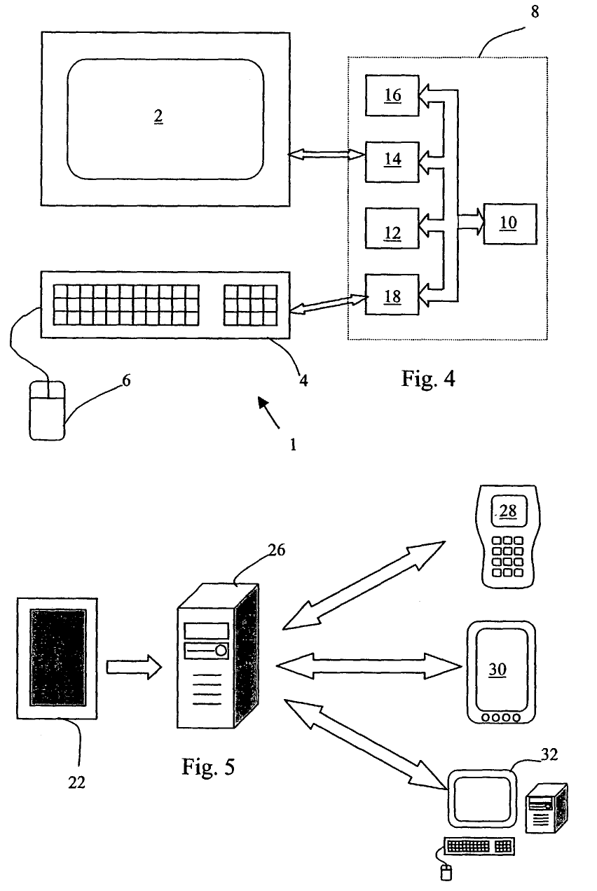

FIG. 4 shows a schematically shows the invention;

FIG. 5 schematically shows a single original document being sent to a number of different data-receiving devices;

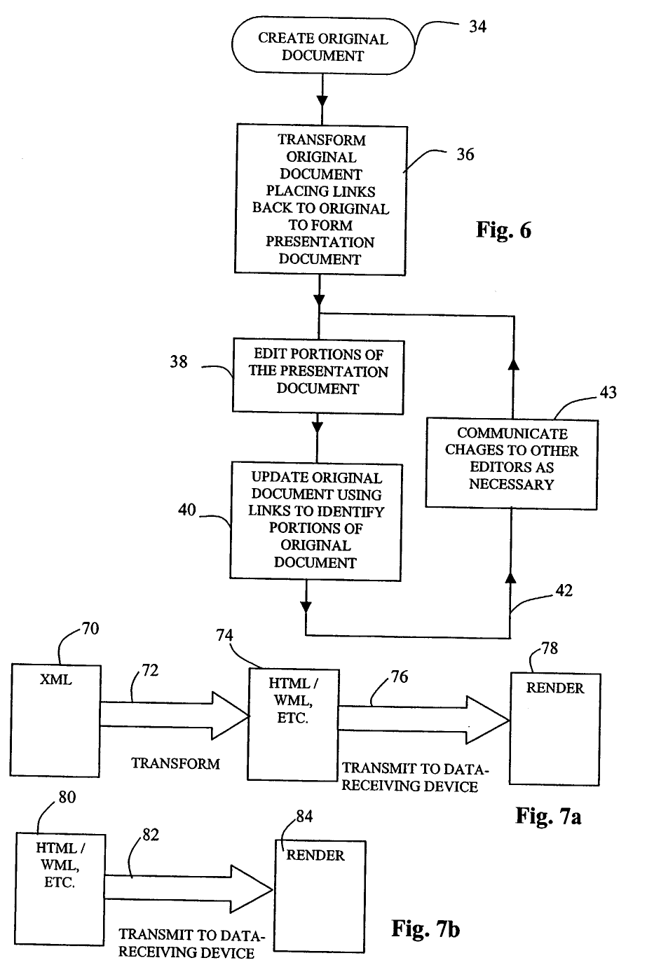

FIG. 6 shows a flow chart briefly outlining a method of using the invention;

FIG. 7 shows two possible embodiments for realising the invention;

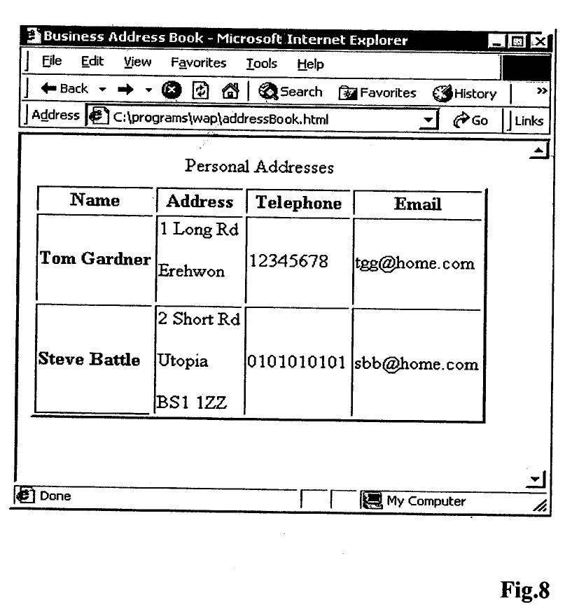

FIG. 8 shows an example of rendered HTML;

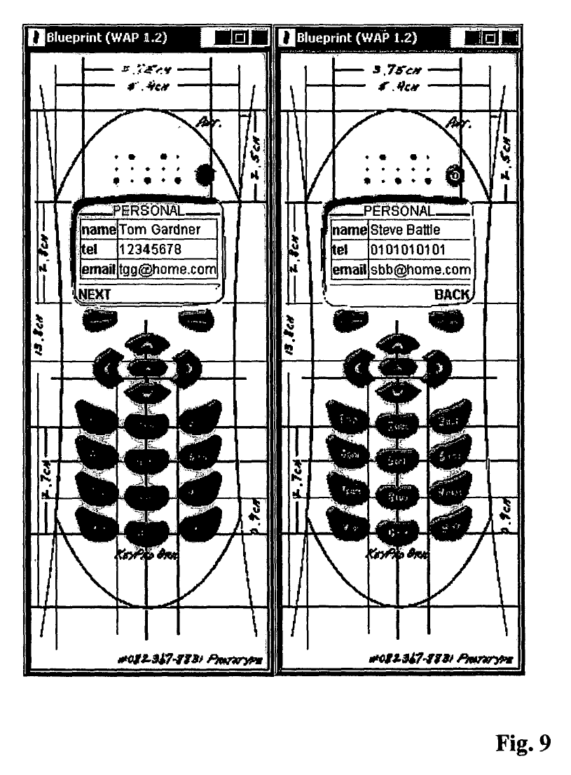

FIG. 9 shows an example of rendered WML; and

Appendix 1 shows example documents and transforms.

FIG. 1 shows a page description 102, which is passed to a renderer 103 which is arranged to render the page description 102 and produce a formatted, published, document 4. FIG. 2 shows a source content document 105 that is passed to an XSL transform 106, which is then itself passed to a renderer 107, arranged to render the information passed thereto into a formatted, published, document 108.

The typical computer system 1 shown in FIG. 4 comprises a display 2, in this case a conventional cathode ray monitor, a keyboard 4, mouse 6 and processing circuitry 8. The processing circuitry comprises a number of sub components: a processor 10, system memory 12, display controller circuitry 14, a mass storage device 16 (in this case a hard drive), and an I/O controller 18. The sub components of the processing circuitry communicate with one another via a system bus 20.

In this embodiment the keyboard and mouse 6 use a universal serial bus (USB) to communicate with the I/O controller 18 of the computer system. Of course other mice 6 and keyboards 4 are well known.

Such a processing circuitry may be provided by a number of different computer systems that are currently available. There is the architecture referred to a PC, which historically is based around the X86 range of processors produced by the INTEL™ Corporation. Other computer system such as those produced by APPLE™, or any other suitable system may be used.

FIG. 4 schematically shows the invention. An original document 22 has been created by some means. For instance, the document may have been created using a text editor, or the like, or may have been received from an external data feed, such as a news feed, etc.

The original document has portions A and B therein and is written in XML. In this case these portions are blocks of text, but could equally be Figures, links to documents, etc.

As in the prior art, to display the XML document it is transformed, in this case using an XSL transform 23, to produce a transformed document, which is then rendered into a presentation document 24. Although the presence of the portions A and B is shown in the presentation document 24, the arrangement of the portions has been changed according to the rules of the XSL transform 23. For example, the presentation document now contains two columns, and the portion A runs for a column and a half.

When the original document 22 is transformed links 27,29 are inserted into the transformed document, which are passed by the renderer into the presentation document 24. These links 27, 29 are written into the transformed document as comments and so are not visible in the presentation document 24 but allow any amendments that are made to the presentation document 24 to be reflected in the original document 22.

As represented in FIG. 5 an original document 22 can be simultaneously transformed into a number of different presentation documents. Processing circuitry 26 can run a plurality of transforms 23 to generate transformed documents that are suitable for rendering and subsequent display on a number of different data-receiving devices. For example one transformed document may be suitable for display on a WAP telephone 28, another may be suitable for display on a PDA 30, and yet another may be suitable for display on a PC 32. As such, the transform 23 would generate a WML transformed document from the original XML document 22, which would be suitable for display on the WAP telephone 28 and would generate an HTML transformed document that would be suitable for display on the other devices.

As well as producing presentation documents suitable for display on a number of different data-receiving devices 28, 30, 32 it is also possible for the transforms 23 to generate presentation documents that only contain a subset of the data held in the original document 22. For example, the original document may comprise an address book containing both personal and work information. The transform 23 may perform filtering that is arranged to generate two separate address books as presentation documents: one containing personal information and one containing work information.

FIG. 6 shows a flow chart that briefly outlines the method of the invention. Once the original document has been created 34, it is transformed into one or more presentation documents 36 with links placed into the presentation documents. Once the, or each, presentation document has been formed it can be edited 38, and the links placed therein allow the original document to be updated accordingly 40. Once presentation documents are in existence this updating of the original document carries on indefinitely, as indicated by the closed loop 42. Within the closed loop 42 any edits made to the presentation document are transmitted to other devices 43 so that they can update the presentation document that they are displaying.

The skilled person will appreciate that the embodiment so far described is represented by FIG. 7a. The original language is defined as a presentation independent mark-up language 70 such as a language defined by an XML specification, transformed 72 to provide a transformed document in a mark-up language providing presentation information 74 (such as HTML, WML, etc.). The transformed document 74 is then transmitted 76 for rendering 78 and display on one or more devices.

FIG. 7b shows an alternative embodiment in which the original document 80 is written in a mark-up language such as HTML, WML, etc. that specifies the presentation. This original document would contain the comments that specify the xpath, etc. and simply needs transmitting 82 to a data-receiving device for rendering 84 and display. The data-receiving device would then allow edits in the rendered version as previously discussed.

Of course, transmitting a document to a data-receiving device includes making the document available on the same processing circuitry. For example a PC could be used to generate a transformed document, and then a browser (or other similar rendering software) could display the generated document on that PC.

Appendix I shows an example source document, example XSL transforms, example HTML, and WML documents produced by the transforms, and examples of the rendered HTML and WML documents.

XML requires pairs of tags to be placed within a document. Theses tags do not specify how the information should be presented, but specify the content of the information between the pairs of tags and define how the marked-up data is to be interpreted. The skilled person will fully understand XML, but a full description can be found at www.w3.org, and the brief description below will aid his/her understanding.

An example original document written in XML, is shown in Appendix I. The skilled person will appreciate how an XML document is structured: written in words, or data sub-items, which are collected into data sub-item groups. The data sub-item groups can comprise sentences, paragraphs, or simply collections of words. The data sub-item groups, or even just data sub-items, are placed between pairs of tags.

The tags appear as follows: <variable>, and </variable>, with variable being any word, or character string. Further, each data sub item group can be itself broken down into a number of sub-items. This structure is convenient and allows for easy manipulation and searching of the complete data-item.

The XML document shown on page 1 of Appendix 1, is an example original document, and shows a simple address book containing the details for two people: Tom Gardner, and Steve Battle. These names can be found between the <name> pairs of tags. The addresses for each of these individuals can be found between the tags <address>, but this address information is broken down into a number of data sub-items: <street>, <town>, and <postcode>. Similar groups can also be seen for <telephone> and <email> details. It should be noted that the XML document contains both personal and business details for the two individuals in the address book.

Page 2 of appendix I shows a possible XSL style sheet that can be run on the XML address book to generate a transformed document. In this case the transformed document is written in HTML and can be rendered by a PC browser, or other similar data-receiving device. The style sheet takes specified portions of the XML document, and generates the HTML code shown on page 4 of Appendix I. The style sheet shown only takes business details for each individual from the XML document.

When rendered the HTML document shown on page 4 appears as shown in FIG. 8. It should be noted the XSL style sheet in transforming the document has filtered the contents of the XML document so that only the personal details of the two individuals have been allowed through. Of course, in other embodiments it would be possible to allow both the personal and business details or just the business details through.

Further, the XSL style sheet has inserted a number of comments in the HTML document, which can be found between pairs of tags <!-- and -->. As will be apparent from the screen shot of FIG. 8 these comments are not displayed in the rendered presentation document. The comments contain information linking data-items in the transformed document to data-items in the original document. The comments work in the same manner as those described below in relation to style sheet to generate an XML transformed document.

Page 6, appendix I, shows a second XSL style sheet also suitable for running on the XML document of appendix 1. However, rather than producing an HTML document, style sheet of page 6 generates a transformed document comprising a WML document suitable for rendering and display on WAP phones, and other similar handheld data-receiving device with low display capabilities. In this example the style sheet also pulls the business details from the XML document.

The WML generated by the WML generation style sheet is shown on page 8 of appendix I, and a picture showing how the XML would appear on a WAP phone (In this example a NOKIA™ telephone) is seen in FIG. 9.

The WML generated by the style sheet also contains comments that appear between the tags <!-- -->, which are ignored when the WML is rendered for displayed, as can be from FIG. 9. The comments are associated with each data sub item, or sub item group that is obtained from the original document. (An item of data sub item may be a name, a telephone number, a line of an address, or similar.) These comments specify the reverse link, or path, from data sub items within the presentation document back to the data in the original document.

The reverse link comprises the XML tags that specify the data-item: for example the comment <!-- xpath=′/AddressBook/Entry [2]/Name/text ( )′ --> (which has been highlighted in bold type in appendix I) specifies that this data-item originates from the XML document “AddressBook”. AddressBook is the opening and closing tag for the XML example shown on page 1 of appendix I. The next portion of the comment specifies Entry[2], i.e. Steve Battle rather than Tom Gardner, since this is the second occurrence of the <Entry> tag. The last portion of the comment specifies the text of “Name”, which completely specifies the data-item within the XML document.

In this embodiment the WAP telephone 28, allows editing of the text appearing thereon. Therefore, to perform an edit a user enters an edit mode and moves a cursor on the screen 44 to the text that they wish to edit. Editing then occurs in a known manner with the user deleting characters and/or entering new characters as desired.

Certain portions of the display that have been introduced in the style sheet transform cannot be edited. In this example this includes the title (“Personal”), the sub-headings (“name”, “tel.”, “email”) and the button labels (“next”, “back”). These portions were not part of the data contained within the original XML document but were added to the WML by the style sheet (for example by the lines:

<card title=“PERSONAL”> and

<td><em>email</em></td>, etc.)

These portions are features of the presentation and are locked. The portions drawn from the original document are the names, the personal telephone numbers and personal emails, which can all be changed. For example the name Steve Battle could be edited to read Steven Battle, etc.

This inverse transformation is achieved by associating the modified text with its original entry in the original document. As discussed above, in the WML document the text “Steve Battle” is preceded by the comment: <!-- xpath=′/AddressBook/Entry [2]/Name/text ( )′ --> Because this is a comment it is not interpreted by the renderer and is consequently not displayed. However, the included xpath uniquely identifies the node in the content document from which the text was obtained. In this example the reference provided by the comment is assumed to be the text of the immediately enclosing <td> element. It should be noted that elements introduced by the transform (title (“Personal”), the sub-headings (“name”, “tel.”, and “email”) and the button labels “next” and “back”) have no associated xpath reference, and so the editor will not allow these to be changed.

The transform has been specifically written to introduce the xpath references giving the transform author control over what data-items may be edited.

In summary therefore the sequence is as follows:

1. A user makes a change to the data-item appearing on a data-receiving device (such as a WAP phone).

2. The editor running on the data-receiving device extracts the path of the data associated with the data-item being edited (if there is no path associated with the data-item then the edit is not allowed).

3. The editor uses the identified path to identify the text in the original document.

4. The text in the original document is changed to that entered on the data-receiving device by notifying the processing circuitry holding the original document about the presentation-document-edit that has occurred.

Once this process has taken place the rendered document and the original document are now consistent so that if the original document were now rendered a document would be displayed that is identical to the one currently displayed. Of course, no such reapplication of the transform is required since the rendered version displayed on the WAP telephone is already correctly displayed.

Variations of this functionality may be applied to increase the efficiency of the process. For example changes to the original document may only be made once changes to the presentation document are complete. This may be indicated by the movement of a cursor out of the data-item being edited, or pressing a key on the data-receiving device. Further, the editor on the data-receiving device may not need to read and write the original document for each change, with the original document being held in a memory of the data-receiving device.

If the original document has undergone multiple transforms to form multiple versions and been sent to a number of data-receiving devices then if an edit is made on one data-receiving device, the document displayed on other data-receiving devices would then be inaccurate and out of date. For example if the original document were transformed into a WML version for display on a WAP telephone 28 and into an HTML version for display on a PC 32, then any changes made to the WML version would need to be reflected in the HTML version.

Such changes could of course be made to all of the versions by transforming and re-rendering the original document, but this may not be as efficient as desired. Therefore, once the original document has been modified in view of changes made to one of the presentation versions (i.e. in view of presentation-document-edits) the processing circuitry on which the original version is stored sends out a notification change to data-receiving devices that have accessed the original document. This notification contains the path reference as well as the new data-item. All of the transforms run on the original document insert paths into the transformed documents produced from the original (e.g. WML, HTML, etc.). Therefore, the notification contains all of the information for the data-receiving device receiving the notification to update the presentation document it is displaying, without having to re-access the original document. This process allows all of the data-receiving devices displaying a presentation document corresponding to the original to be updated by an edit made on one of the data-receiving devices.

In further embodiments passwords and/or access rights may be provided to control editing of the data. In one embodiment the original document is provided with a field holding the data “YOUR NAME HERE”. A user edits this field in the presentation document to enter their name. However, the user cannot cause the original document to be overwritten otherwise the original, useful, contents of the field would be lost. Instead the user must save the new version as a different file. If the user can enter a predetermined password they are able to edit and save the original document.

[image]

[image]

[image]

[image]

[image]

[image]

[image]

[image]

[image]

1. A method of facilitating the amendment of data, said data comprising a presentation document that has been rendered from an original document, wherein said method comprises marking the presentation document and allowing said presentation document to have amendments made thereto such that when said presentation document has amendments made thereto said original document has corresponding amendments made thereto.

2. A method according to claim 1 wherein said presentation document comprises at least one portion and said original document comprises a corresponding portion to the at least one portion of said presentation document, said method comprising marking said presentation document by inserting at least one link, said at least one link being arranged to link said at least one portion of said presentation document to said corresponding portion in said original document.

3. A method according to claim 2 wherein said at least one link comprises a path to said corresponding portion of said original document.

4. A method according to claim 2, wherein said method comprises allowing only portions of said presentation document that have at least one of said links associated therewith to be amended in said presentation document.

5. A method according to claim 1 comprising providing processing circuitry arranged to hold said original document and at least one data-receiving device remote from said processing circuitry, capable of receiving data and arranged to display said presentation document, said method comprising causing said at least one data receiving device to display said presentation document.

6. A method according to claim 5 wherein said processing circuitry is capable of transmitting data, and said method comprises causing said processing circuitry to transmit said original document to said at least one data-receiving device to cause said presentation document to be displayed.

7. A method according to claim 1 comprising providing processing circuitry holding said original document and capable of transforming said original document wherein said method comprises causing said processing circuitry to transform said original document to produce a transformed document arranged to be rendered.

8. A method according to claim 5 wherein said processing circuitry is capable of transforming data and said method comprises causing said processing circuitry to transform said original document to produce a transformed document arranged to be rendered.

9. A method according to claim 8 wherein said processing circuitry is capable of transmitting data and said method comprises transmitting said transformed document to said at least one data-receiving devices to cause said presentation document to be rendered and displayed thereon.

10. A method according to claim 1 wherein said original document and said presentation document each comprise a plurality of data items and said method comprises rendering only a portion of said data-items appearing in said original document to produce said presentation document.

11. A method according to claim 1 comprising providing a set of tools, said set of tools being arranged for use in marking said presentation document.

12. A method according to claim 5 wherein said at least one data-receiving device is arranged to allow said presentation document to be edited and is capable of transmitting data, said processing circuitry is capable of receiving said data transmitted from said at least one data receiving device and of amending said original document held thereon, said data sent from said at least one data receiving device comprising any presentation-document-edits that have been made to said presentation document displayed thereon , and said method comprising causing said data-receiving device to transmit said data to said processing circuitry on which said original document is held, and based upon said data, said processing circuitry making amendments to said original document.

13. A method according to claim 12, wherein said processing circuitry is capable of transmitting said data received from said at least one data receiving device, and said method comprises causing said processing circuitry to transmit said data on receipt thereof from said at least one data receiving device to substantially all data-receiving devices that are displaying said presentation document.

14. A method according to claim 12 wherein said data sent from said at least one data receiving device further comprises the location of the amendment to be made within said original document.

15. A method according to claim 12 comprising causing said data sent from said at least one data receiving device to specify an amendment to be made to said original document.

16. A computer readable medium arranged to store therein instructions for causing a processing unit to execute said method according to claim 1.

17. A data-receiving device arranged to receive data and further arranged to render said data into a presentation document according to claim 1.

18. A data-receiving device according to claim 17 comprising any one of the following: a WAP telephone; a web-enabled television; a PC (or other web enabled computer e.g. an Apple); an ebook; a PDA; any other similar data-receiving device.

19. A data-receiving device according to claim 17 arranged to allow said presentation document rendered thereon to edited.

20. A data-receiving device according to claim 19 which comprises a transmitter, said transmitter being arranged to transmit any edits that are made to said presentation document being displayed thereon.

21. A data-receiving device according to claim 20 which is arranged such that said transmitter only transmits said edit once said edit has been completed.

22. A system comprising a transmitter capable of transmitting a document and processing circuitry arranged to generate at least one document, said at least one document comprising at least one data-item, said processing circuitry being capable of inserting into said document at least one link, said link specifying the location of said at least one data-item within said document, said processing circuitry being capable of transmitting said document using said transmitter.

23. A system according to claim 22 that comprises at least one data-receiving device arranged to receive said document transmitted by said processing circuitry.

24. A system according to claim 23 wherein said at least one data-receiving device is capable of rendering said document and is arranged to render said document for display thereon.

25. A system according to claim 22 wherein said processing circuitry is arranged to handle said documents written in a presentation independent mark-up language.

26. A system according to claim 25 wherein said processing circuitry is arranged to transform said document written in said presentation independent mark-up language to produce a document suitable for transmission.

27. A system according to claim 22 wherein said processing circuitry is arranged such that said documents generated thereby are written in a mark-up language that specifies a display format for said document.

28. A system according to claim 22 wherein said data-receiving device is a data-receiving device according to claim 17.

29. A method of facilitating the amendment of data, said data comprising a presentation document that has been rendered from an original document, wherein said method comprises marking the presentation document and allowing said presentation documents to have amendments made thereto such that when said presentation document has amendments made thereto said original document has corresponding amendments made thereto and wherein said presentation document comprises at least one portion and said original document comprises a corresponding portion to the at least one portion of said presentation document, said method comprising marking said presentation document by inserting at least one link, said at least one link being arranged to link said at least one portion of said presentation document to said corresponding portion in said original document.

30. A system comprising a transmitter means for transmitting information and capable of transmitting a document and a processing means for processing data and arranged to generate at least one document, said at least one document comprising at least one data-item, said processing means being capable of inserting into said document at least one link, said link specifying the location of said at least one data-item within said document, said processing circuitry being capable of transmitting said document using said transmitter.
